(19) United States
(12) Patent Application Publication
(10) Pub. No.: US 2011/0215672 A1
(43) Pub. Date: Sep. 8, 2011

(54) MEMS DEVICE

(75) Inventors: TOHRU YAMAOKA, Niigata (JP); YUICHI MIYOSHI, Niigata (JP); YUSUKE TAKEUCHI, Kanagawa (JP)

(73) Assignee: PANASONIC CORPORATION, Osaka (JP)

(21) Appl. No.: 13/109,371

(22) Filed: May 17, 2011

Related U.S. Application Data
(63) Continuation of application No. PCT/JP2009/007272, filed on Dec. 25, 2009.

(30) Foreign Application Priority Data
Jan. 9, 2009 (JP) 2009-003455

(51) Int. Cl. H02N 1/00

(52) U.S. Cl. 310/300

(57) ABSTRACT

A MEMS device includes: a semiconductor substrate; a vibrating film formed on the semiconductor substrate with a restraining portion interposed between the vibrating film and the semiconductor substrate, and including a lower electrode, and a fixed film formed on the semiconductor substrate with a support portion interposed between the fixed film and the semiconductor substrate to cover the vibrating film, and including an upper electrode. A gap formed between the vibrating film and the fixed film opposed to each other forms an air gap. The restraining portion provides partial coupling between the semiconductor substrate and the vibrating film, and the vibrating film has a multilayer structure in which the lower electrode and a compressive stress inducing insulating film are laminated. The insulating film is located within the perimeter of the lower electrode.

### CROSS-REFERENCE TO RELATED APPLICATIONS

This is a continuation of PCT International Application PCT/JP2009/007272 filed on Dec. 25, 2009, which claims priority to Japanese Patent Application No. 2009-3455 filed on Jan. 9, 2009. The disclosures of these applications including the specifications, the drawings, and the claims are hereby incorporated by reference in their entirety.

### BACKGROUND

The present disclosure relates to MEMS devices each having a multilayer vibrating film.

Microelectromechanical systems (MEMS) devices to which semiconductor technologies are applied are a promising technology for reducing the size of and improving the performance of conventional electronic components. The use of the semiconductor technologies allows a vibrating film determining the device characteristics of a sensor or a transducer to have a multilayer structure including multiple thin films. Japanese Patent Publication No. 2001-194201 describes a technique in which one, having the greatest breaking strength, of multiple thin films forming a multilayer vibrating film of a sensor is used as at least one of the outermost layers located toward the top and back surfaces of the vibrating film, thereby improving the breaking strength of the vibrating film without increasing the thickness thereof. Furthermore, Japanese Patent Publication No. 2002-518913 describes a method for adjusting the tension which determines a characteristic of a multilayer vibrating film of a transducer.

### SUMMARY

In recent years, MEMS sensors or MEMS transducers have been used mainly for mobile equipment, and thus, there has been an increasing demand to reduce the chip size of such a sensor or such a transducer. Therefore, the area of a vibrating film having an influence on the characteristics, i.e., the area of a movable electrode, needs to be reduced.

A general expression of the sensitivity S of an acoustic transducer in the audible range is approximately represented by:

S=α×Ca×Va×(1/S₀) (1)

where α represents a proportionality factor, Ca represents an air gap capacitance (proportional to (movable electrode area Sdia/air gap length d₀)) which includes a movable electrode, Va represents a voltage across the air gap, and S₀ represents stiffness (difficulty in movement) of the vibrating film.

As can also be seen from expression (1), when the voltage Va across the air gap and the vibrating film stiffness S₀ are fixed, a reduction in the movable electrode area Sdia reduces the air gas capacitance Ca, thereby reducing the sensitivity S. Advantageous methods for reducing the movable electrode area Sdia without reducing the sensitivity S include increasing the voltage Va across the air gap or reducing the vibrating film stiffness S₀.

Here, in order to reduce the vibrating film stiffness S₀, the stress exerted on the vibrating film needs to be reduced, and the acoustic transducer needs to have a structure configured to reduce the area of a restraining portion through which the vibrating film is structurally coupled to a silicon substrate (hereinafter referred to as a partially restraining structure).

When the chip size is reduced to approximately 1 mm² so as to be fitted to mobile equipment, the stress of the vibrating film needs to be reduced to several MPa, and the ratio of the planar width of the restraining portion to the planar perimeter of the vibrating film needs to be approximately 10%. However, when the stress exerted on the multilayer vibrating film is reduced, stress differences among thin films forming the multilayer structure cause deformation in the vibrating film, thereby preventing control of the air gap capacitance Ca (air gap length d₀) and the vibrating film stiffness S₀. This cannot provide a desired sensitivity characteristic.

In order to solve the above problem, a MEMS device according to a first aspect of the present disclosure includes: a semiconductor substrate; a vibrating film formed on the semiconductor substrate with a restraining portion interposed between the vibrating film and the semiconductor substrate, and including a first electrode, and a fixed film formed on the semiconductor substrate with a support portion interposed between the fixed film and the semiconductor substrate to cover the vibrating film, and including a second electrode. A gap formed between the vibrating film and the fixed film opposed to each other forms an air gap or air gap layer, the restraining portion provides partial coupling between the semiconductor substrate and the vibrating film, the vibrating film has a multilayer structure in which the first electrode and a first insulating film inducing a compressive stress are laminated, and the first insulating film is located within the perimeter of the first electrode.

According to the MEMS device of the first aspect of the present disclosure, the vibrating film has a multilayer structure in which the first electrode and the first insulating film inducing a compressive stress are laminated, and the first insulating film is located within the perimeter of the first electrode. This can reduce film deformation arising from the stress differences among the layers forming the vibrating film even when a tensile stress acts on the restraining portion providing partial coupling between the vibrating film and the semiconductor substrate.

In the MEMS device according to the first aspect of the present disclosure, the vibrating film may include a second insulating film inducing a tensile stress and a third insulating film inducing a tensile stress, the second insulating film may be formed on the first insulating film, and the third insulating film may be formed under the first insulating film.

In this case, at least one of the second and third insulating films may be formed on a region except for a region including the restraining portion and a surrounding area of the restraining portion.

In the MEMS device according to the first aspect of the present disclosure, a plurality of grooves may be formed in the first insulating film to cross one another, and the first insulating film may be separated into a plurality of sections by the grooves.

When the MEMS device according to the first aspect of the present disclosure includes the second and third insulating films, the second and third insulating films may be silicon nitride films.

In the MEMS device according to the first aspect of the present disclosure, the first insulating film may be a silicon oxide film.

A MEMS device according to a second aspect of the present disclosure includes: a semiconductor substrate; a vibrating film formed on the semiconductor substrate with a restraining portion interposed between the vibrating film and the semiconductor substrate, and including a first electrode, and a fixed film formed on the semiconductor substrate with a support portion interposed between the fixed film and the semiconductor substrate to cover the vibrating film, and including a second electrode. A gap formed between the vibrating film and the fixed film opposed to each other forms an air gap or air gap layer, the restraining portion provides partial coupling between the semiconductor substrate and the vibrating film, the vibrating film has a multilayer structure in which the first electrode, and a first insulating film inducing a compressive stress, and a second insulating film inducing a compressive stress are laminated, the first insulating film is formed on the first electrode, and the second insulating film is formed under the first electrode.

According to the MEMS device of the second aspect of the present disclosure, the restraining portion provides partial coupling between the semiconductor substrate and the vibrating film, the vibrating film has a multilayer structure in which the first electrode, and the first insulating film inducing a compressive stress, and the second insulating film inducing a compressive stress are laminated, the first insulating film is formed on the first electrode, and the second insulating film is formed under the first electrode. This can reduce film deformation arising from the stress differences among the layers forming the vibrating film even when a tensile stress acts on the restraining portion providing partial coupling between the vibrating film and the semiconductor substrate.

In the MEMS device according to the second aspect of the present disclosure, the vibrating film may include a third insulating film inducing a tensile stress and a fourth insulating film inducing a tensile stress, the third insulating film may be formed on the first insulating film, and the fourth insulating film may be formed under the second insulating film.

In this case, at least one of the third and fourth insulating films may be formed on a region except for a region including the restraining portion and a surrounding area of the restraining portion.

In the MEMS device according to the second aspect of the present disclosure, a plurality of grooves may be formed in the first insulating film to cross one another, and the first insulating film may be separated into a plurality of sections by the grooves.

In the MEMS device according to the second aspect of the present disclosure, a plurality of grooves may be formed in the second insulating film to cross one another, and the second insulating film may be separated into a plurality of sections by the grooves.

When the MEMS device according to the second aspect of the present disclosure includes the third and fourth insulating films, the third and fourth insulating films may be silicon nitride films.

In the MEMS device according to the second aspect of the present disclosure, the first and second insulating films may be silicon oxide films.

Clearly, the above-described features can be consistently and appropriately combined together. Also when multiple advantages can be expected from the features, all the advantages do not need to be provided.

According to the MEMS device of the present disclosure, even when the size of a movable electrode in the vibrating film is reduced, a desired sensitivity characteristic can be provided by reducing deformation in the vibrating film arising from the stress differences among the thin films forming the multilayer vibrating film. This enables miniaturization of the MEMS device while maintaining the sensitivity characteristic.

### BRIEF DESCRIPTION OF THE DRAWINGS

FIG. 1 is a cross-sectional view illustrating a MEMS device, i.e., an acoustic transducer, according to a first embodiment of the present disclosure.

FIG. 2 is a plan view illustrating a vibrating film of the MEMS device, i.e., the acoustic transducer, according to the first embodiment of the present disclosure.

FIG. 3 is a cross-sectional view taken along the line III-III in FIG. 2.

FIG. 4 is a cross-sectional view illustrating a MEMS device, i.e., an acoustic transducer, according to a second embodiment of the present disclosure.

FIG. 5 is a plan view illustrating a vibrating film of a MEMS device, i.e., the acoustic transducer, according to the second embodiment of the present disclosure.

FIG. 6 is a cross-sectional view taken along the line VI-VI in FIG. 5.

FIGS. 7A and 7B are cross-sectional views illustrating process steps in a method for fabricating a MEMS device according to the second embodiment of the present disclosure in a sequential order.

FIGS. 8A and 8B are cross-sectional views illustrating other process steps in the method for fabricating a MEMS device according to the second embodiment of the present disclosure in a sequential order.

FIGS. 9A and 9B are cross-sectional views illustrating other process steps in the method for fabricating a MEMS device according to the second embodiment of the present disclosure in a sequential order.

FIGS. 10A and 10B are cross-sectional views illustrating other process steps in the method for fabricating a MEMS device according to the second embodiment of the present disclosure in a sequential order.

FIGS. 11A and 11B are cross-sectional views illustrating other process steps in the method for fabricating a MEMS device according to the second embodiment of the present disclosure in a sequential order.

FIGS. 12A and 12B are cross-sectional views illustrating other process steps in the method for fabricating a MEMS device according to the second embodiment of the present disclosure in a sequential order.

FIG. 13 is a cross-sectional view illustrating another process step in the method for fabricating a MEMS device according to the second embodiment of the present disclosure.

FIG. 14 is a cross-sectional view illustrating an acoustic transducer according to a variation of the second embodiment of the present disclosure.

FIG. 15 is a plan view illustrating a vibrating film of the acoustic transducer according to the variation of the second embodiment of the present disclosure.

FIG. 16 is a cross-sectional view taken along the line XVI-XVI in FIG. 15.

FIG. 17 is a cross-sectional view illustrating a MEMS device, i.e., an acoustic transducer, according to a third embodiment of the present disclosure.

FIG. 18 is a plan view illustrating a vibrating film of the MEMS device, i.e., the acoustic transducer, according to the third embodiment of the present disclosure.

FIG. 19 is a cross-sectional view taken along the line XIX-XIX in FIG. 18.

FIG. 20 is a cross-sectional view illustrating a MEMS device, i.e., an acoustic transducer, according to a fourth embodiment of the present disclosure.

FIG. 21 is a plan view illustrating a vibrating film of the MEMS device, i.e., the acoustic transducer, according to the fourth embodiment of the present disclosure.

FIG. 22 is a cross-sectional view taken along the line XXII-XXII in FIG. 21.

### DETAILED DESCRIPTION

### First Embodiment

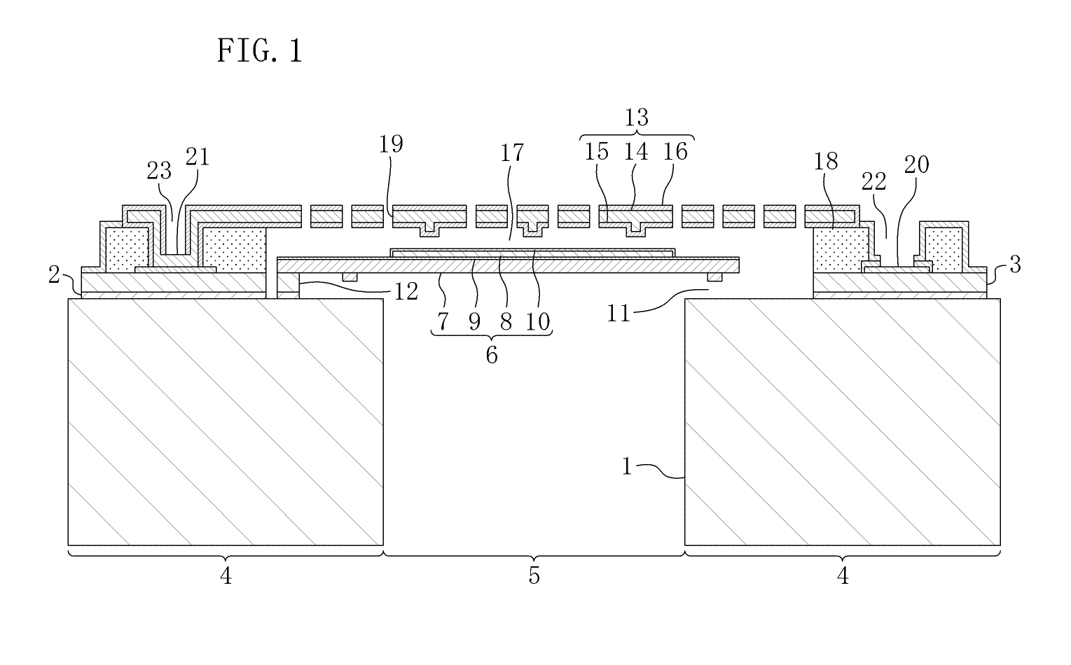

An acoustic transducer according to a first embodiment of the present disclosure will be described with reference to FIGS. 1-3. The drawings, various shapes, materials, and numeric values which will be described below are all set forth merely for purposes of preferred examples, and are not limited to the contents described below. Appropriate changes can be made without being limited to the description below as long as doing so does not depart from the spirit of the invention. Furthermore, this embodiment can be also combined with other embodiments as long as this embodiment is consistent with the other embodiments. Although an acoustic transducer is described here while being used as an example of a MEMS device, the present disclosure can be practiced with general MEMS devices. Although described below, MEMS devices denote a transducer element formed using a semiconductor process to transduce a mechanical signal, etc., into an electrical signal, etc. Examples of MEMS devices include acoustic transducers (MEMS microphones), pressure sensors, acceleration sensors, and angular velocity sensors. The above description is shared by embodiments of the present disclosure.

First, the structure of an acoustic transducer according to the first embodiment of the present disclosure will be described. FIG. 1 illustrates a cross-sectional view of the acoustic transducer according to the first embodiment of the present disclosure.

As illustrated in FIG. 1, a first silicon oxide film 2 and a second silicon oxide film 3 are formed on a silicon substrate 1. A portion of the silicon substrate 1 is removed so that a peripheral portion 4 of the silicon substrate 1 remains, thereby forming a removed substrate region 5. Specifically, in order to allow a vibrating film 6 described below to vibrate under external pressure, the removed substrate region 5 is formed by selectively removing the silicon substrate 1 (so that the peripheral portion 4 remains).

The vibrating film 6 is formed on the silicon substrate 1 to cover the removed substrate region 5. The vibrating film 6 is made of either a conductive film forming a lower electrode (vibrating electrode) or a multilayer film including an insulating film. In particular, when the vibrating film 6 includes an electret film holding permanent charge, it can form a portion of an electret capacitor. This can eliminate the need for supplying a voltage from outside.

In this embodiment, the vibrating film 6 includes a lower electrode 7 which is a conductive film of polysilicon, etc., an insulating film 8 formed on the lower electrode 7 and made of silicon oxide, etc., and insulating films 9 and 10 made of silicon nitride, etc. The insulating film 9 covers the lower surface of the insulating film 8, and the insulating film 10 covers the upper and side surfaces thereof. However, the side surfaces of the insulating film 8 may be covered with either of the insulating films 9 and 10. The insulating film 8 is formed within the removed substrate region 5.

An air gap or air gap layer 11 is formed between the vibrating film 6 and the silicon substrate 1, and restraining portions 12 including the first silicon oxide film 2 and the second silicon oxide film 3 are formed between a region of the vibrating film 6 under which the air gap layer 11 is not formed and the silicon substrate 1 to support the vibrating film 6. The vibrating film 6 is structurally coupled to the silicon substrate 1 through the restraining portions 12.

A fixed film 13 is located above the vibrating film 6. The fixed film 13 is made of either a single conductive film forming an upper electrode (fixed electrode) or a multilayer film including an insulating film. In particular, when the fixed film 13 includes an electret film holding permanent charge and made of silicon oxide, etc., it can form a portion of an electret capacitor. This can eliminate the need for supplying a voltage from outside. In this embodiment, the fixed film 13 includes an upper electrode 14 which is a conductive film of polysilicon, etc., and insulating films 15 and 16 made of silicon nitride, etc. The insulating film 15 covers the lower surface of the upper electrode 14, and the insulating film 16 covers the upper and side surfaces thereof. However, the side surfaces of the upper electrode 14 may be covered with either of the insulating films 15 and 16.

An air gap or air gap layer 17 is formed between the vibrating film 6 and the fixed film 13, and a support portion 18 made of silicon oxide is formed between a region of the second silicon oxide film 3 on which the air gap layer 17 is not formed and the fixed film 13 to support the fixed film 13.

The air gap layer 17 is formed at least over the entire removed substrate region 5 by removing a portion of the silicon oxide film forming the support portion 18.

A plurality of acoustic holes 19 which penetrate to the air gap layer 17 are formed in the fixed film 13 on the air gap layer 17. The acoustic holes 19 serve as holes through which air vibrating the vibrating film 6 passes.

A first opening 22 and a second opening 23 are formed in the support portion 18 to expose a pad portion 20 of the lower electrode 7 and a pad portion 21 of the upper electrode 14. Although not shown, the pad portions 20 and 21 are connected to an external circuit by wire bonding.

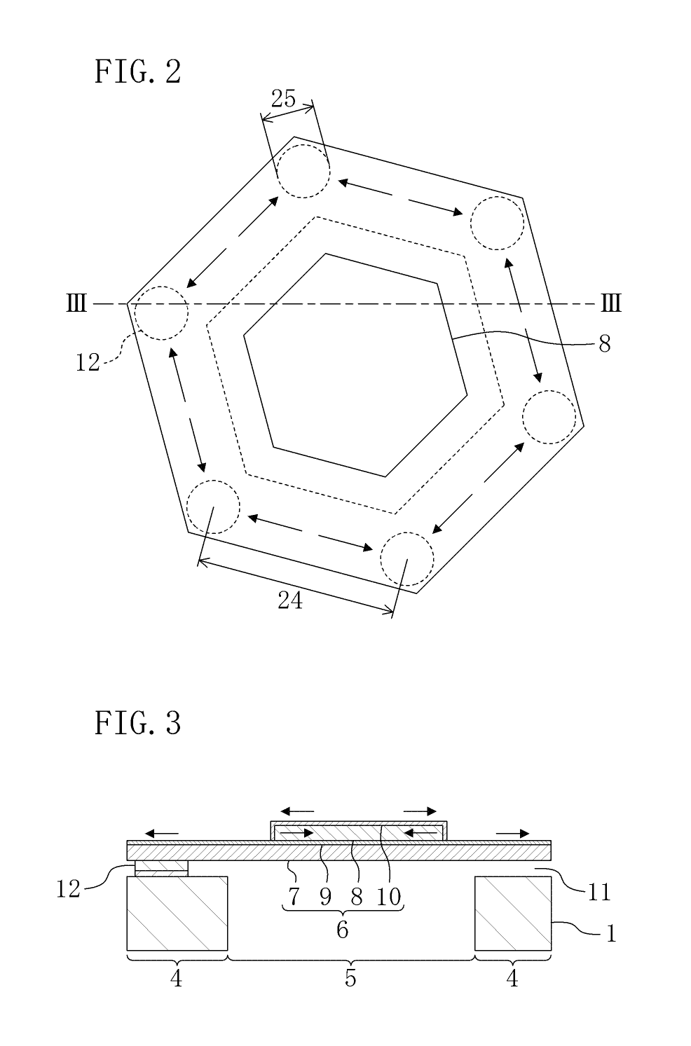

Next, the structure of the vibrating film of the acoustic transducer according to the first embodiment of the present disclosure will be described in detail. FIG. 2 illustrates a planar structure of the vibrating film of the acoustic transducer according to the first embodiment of the present disclosure, and FIG. 3 illustrates a cross-sectional structure of the vibrating film of the acoustic transducer according to the first embodiment of the present disclosure. Here, FIG. 3 illustrates a cross-sectional shape taken along the line III-III in FIG. 2.

As can be seen from FIG. 2, the vibrating film 6 forms a generally regular hexagonal shape in plan view, and each of the restraining portions 12 forms a generally circular shape in plan view. However, the vibrating film 6 may form a polygonal shape, such as a generally quadrangular shape or a generally hexagonal shape, or a generally circular shape in plan view instead of a generally regular hexagonal shape. The restraining portion 12 may form a polygonal shape, such as a generally quadrangular shape or a generally hexagonal shape, in plan view instead of a generally circular shape. The reference character 24 denotes the distance between the centers of each adjacent pair of the restraining portions 12 (hereinafter referred to as L1), and the reference character 25 denotes the diameter of each restraining portion 12 (hereinafter referred to as L2).

As can be seen from FIG. 3, the vibrating film 6 includes a lower electrode 7 which is a substantially stress-free conductive film of polysilicon, etc., an insulating film 8 formed on the lower electrode 7 and made of silicon oxide, etc., with a compressive stress of ⁻500-⁻100 MPa, and insulating films 9 and 10 made of silicon nitride, etc., with a tensile stress of 1000-2000 MPa. The insulating film 9 covers the lower surface of the insulating film 8, and the insulating film 10 covers the upper and side surfaces thereof. Here, the insulating film 8 is formed within the removed substrate region 5. The entire compressive stress inducing insulating film 8 does not need to be located within the removed substrate region 5. The insulating film 8 may be located, for example, at least within the lower electrode 7 or at least inwardly of the restraining portions 12.

The silicon oxide film with a compressive stress of ⁻500-⁻100 MPa can be formed, for example, by chemical vapor deposition (CVD) using tetraethoxysilane. The silicon oxide film formed by CVD using silane-based gas also provides similar advantages as long as it is a compressive stress inducing insulating film.

The silicon nitride film with a tensile stress of 1000 MPa-2000 MPa can be formed, for example, by CVD using silane-based gas and ammonia.

As can be seen from FIGS. 2 and 3, the directions of the stresses applied to the lower electrode 7, the insulating film 8, and the insulating films 9 and 10 are illustrated by arrows. As described above, the vibrating film 6 includes the compressive stress inducing insulating film 8, the substantially stress-free lower electrode 7, and the tensile stress inducing insulating films 9 and 10. The compressive stress inducing insulating film 8 is formed within the removed substrate region 5. By contrast, the tensile stress inducing insulating films 9 and 10 are formed on the substantially entire surface of the lower electrode 7. Therefore, as illustrated in FIGS. 2 and 3, a tensile stress is applied from the restraining portions 12 to the vibrating film 6 on the air gap layer 11. The reason for this is that the edges of a compressive stress inducing insulating film 8 are located inwardly of the edges of the tensile stress inducing insulating film 9 (i.e., the edges of the vibrating film 6) in order to allow the influence of the tensile stress inducing insulating films 9 and 10 to be greater than that of the compressive stress inducing insulating film 8.

Next, operation of the acoustic transducer of this embodiment will be described with reference to FIG. 1. In the acoustic transducer of this embodiment, when sound pressure is applied from above (outside) to the vibrating film 6 via the plurality of acoustic holes 19, the vibrating film 6 mechanically and vertically vibrates in response to the sound pressure. Here, a parallel-plate capacitor structure using the lower electrode 7 and the upper electrode 14 as electrodes is formed. Therefore, when the vibrating film 6 vibrates, the distance between the lower electrode 7 and the upper electrode 14 changes, and therefore, the capacitance (Ca) of the capacitor changes. On the other hand, if it is assumed that the capacitance (Ca) changes under the condition that the amount of charge (Qa) accumulated in the capacitor is constant, a voltage (Va) between the lower electrode 7 and the upper electrode 14 changes in accordance with the relationship indicated by expression (2) (as indicated by expression (3)). The amount of a change in the capacitance Ca is hereinafter referred to as ΔCa, and the amount of a change in the voltage Va is hereinafter referred to as ΔVa.

Qa=Ca×Va (2)

ΔVa=Qa/ΔCa (3)

In other words, the vibration of air is converted into mechanical vibration, and then into a change ΔVa in voltage. This is the operating principle of the acoustic transducer of this embodiment.

Next, sensitivity which indicates a characteristic of acoustic transducers will be described. As described above, a general expression of the sensitivity S of an acoustic transducer in the audible range is approximately represented by:

S=α×Ca×Va×(1/S₀) (1)

where a represents a proportionality factor, Ca represents an air gap capacitance which is a variable portion and is represented by expression (4) described below, Va represents a voltage across the air gap, and S₀ represents a stiffness (difficulty in movement) of the vibrating film.

Ca=ε₀×ε×(Sdia/d₀) (4)

where ε₀ represents the dielectric constant in a vacuum, ε represents the average relative dielectric constant between the lower electrode 7 and the upper electrode 14, Sdia represents the area of the movable electrode, and d₀ represents the distance between the electrodes.

As can be seen also from expressions (1) and (4), the vibrating film stiffness S₀ needs to be reduced in order to reduce the movable electrode area Sdia without reducing the sensitivity S. In order to reduce the vibrating film stiffness S₀, the stress exerted on the vibrating film needs to be reduced, and the acoustic transducer needs to have a structure configured to reduce the area of the restraining portion 12 through which the vibrating film is structurally coupled to the silicon substrate 1 (a partially restraining structure). When the components of the vibrating film 6 are determined, the vibrating film stiffness S₀ is represented by:

$$\begin{matrix}{S}_{0} = ( σ \times A ) / ( 6 \times L 1 ) \\ = ( σ \times 6 \times L 2 \times T ) / ( 6 \times L 1 ) \\ = σ \times T \times ( L 2 / L 1 )\end{matrix} \qquad ( 5 )$$

where σ represents the stress exerted on the vibrating film 6 (the force acting per unit area of the vibrating film 6), A represents the cross-sectional area of a portion of the vibrating film 6 located on each restraining portion 12, L1 represents the distance between the centers of each adjacent pair of the restraining portions 12, and L2 represents the diameter of each restraining portion 12, and T represents the thickness of the vibrating film 6.

Here, the vibrating film stiffness S₀ of the acoustic transducer of this embodiment will be described in detail.

As illustrated in FIG. 3, a portion of the vibrating film 6 located on the air gap layer 11 is released from the silicon substrate 1, i.e., not in contact with the silicon substrate 1. As illustrated in FIG. 2, a tensile stress from each restraining portion 12 is applied to a portion of the vibrating film 6 located on the air gap layer 11. Therefore, the vibrating film 6 and the silicon substrate 1 are not in contact with each other. Consequently, the residual stress caused due to the difference in thermal expansion coefficient between the vibrating film 6 and the silicon substrate 1 does not act on the vibrating film 6. In other words, the tensile stress from each restraining portion 12 can prevent the vibrating film 6 and the silicon substrate 1 from being in contact with each other.

By contrast, when the influence of the tensile stress inducing insulating films 9 and 10 is too strong, a phenomenon occurs in which an unrestraining portion of the vibrating film 6 (the portion of the vibrating film 6 which is not restrained by the silicon substrate 1) is bent upward. Therefore, in order to reduce the upward bend in the vibrating film 6, the compressive stress inducing insulating film 8 is formed within the removed substrate region 5. This can reduce the influence of the tensile stress inducing insulating films 9 and 10 using the influence of the compressive stress inducing insulating film 8. Consequently, the upward bend in the unrestraining portion of the vibrating film 6 can be reduced.

As described above, a tensile stress inducing insulating film and a compressive stress inducing insulating film are laminated, and the compressive stress insulating film is located within the tensile stress inducing insulating film, thereby reducing film deformation arising from the stress differences among the layers forming the vibrating film. This can provide desired vibrating film stiffness.

Therefore, referring to expression (5), when the length L2 of the diameter 25 of each restraining portion 12 is set, e.g., at 50% of the distance L1 between the centers of each adjacent pair of the restraining portions 12, the tension S₀ of the vibrating film 6 per unit length thereof can be reduced to approximately 50% as compared with when the entire perimeter of the vibrating film 6 is restrained by the silicon substrate 1 without forming a plurality of spaced restraining portions 12. The reason for this is that deformation in the vibrating film 6 has been reduced. As a result, according to expressions (1) and (4), the movable electrode area Sdia can be reduced to 50% without reducing the sensitivity S of the acoustic transducer, thereby reducing the chip size.

As described above, a major feature of the acoustic transducer of the first embodiment of the present disclosure is that the vibrating film has a multilayer structure in which the electrode and the compressive stress inducing insulating film are laminated, and the compressive stress inducing insulating film is located within the electrode. The reason for this is that such a structure can reduce the upward bend in the unrestraining portion of the vibrating film due to a too strong influence of the tensile stress even when a tensile stress acts on the vibrating film and the restraining portions through which the vibrating film and the silicon substrate are partially coupled together. This can further reduce film deformation arising from the stress differences among the layers forming the vibrating film.

The vibrating film preferably further includes a tensile stress inducing insulating film, and the tensile stress inducing insulating film is preferably formed to extend to the edges of the vibrating film. The reason for this is that the above structure facilitates exerting a tensile stress on the restraining portions, thereby further enhancing the advantage provided by locating the compressive stress inducing insulating film within the electrode.

In this embodiment, the vibrating film 6 formed by sequentially laminating the lower electrode 7, the tensile stress inducing insulating film 9, the compressive stress inducing insulating film 8, and the tensile stress inducing insulating film 10 as illustrated in FIGS. 1-3 has been described. In other words, the vibrating film 6 including the compressive stress inducing insulating film 8 and the tensile stress inducing insulating film 9 located immediately below the insulating film 8 has been described. However, the tensile stress inducing insulating film 9 may be formed on the lower surface of the lower electrode 7 without being located immediately below the compressive stress inducing insulating film 8. With this structure, the tensile stress inducing insulating film 9 is vertically symmetric to the tensile stress inducing insulating film 10 about the in-plane direction of the lower electrode 7. This can further reduce film deformation arising from the stress differences among the layers forming the vibrating film 6.

### Second Embodiment

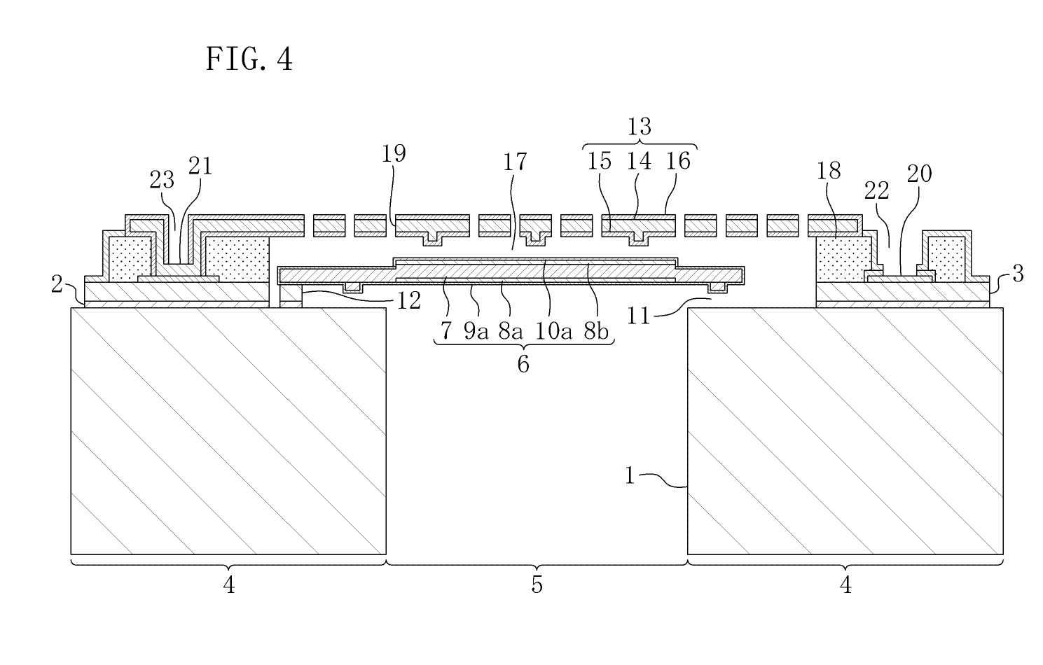

An acoustic transducer according to a second embodiment of the present disclosure will be described hereinafter with reference to FIGS. 4-6. The drawings, various shapes, materials, and numeric values which will be described below are all set forth merely for purposes of preferred examples, and are not limited to the contents described below. Appropriate changes can be made without being limited to the description below as long as doing so does not depart from the spirit of the invention. Furthermore, this embodiment can be also combined with other embodiments as long as this embodiment is consistent with the other embodiments. Although an acoustic transducer is described here while being used as an example of a MEMS device, the present disclosure can be practiced with general MEMS devices.

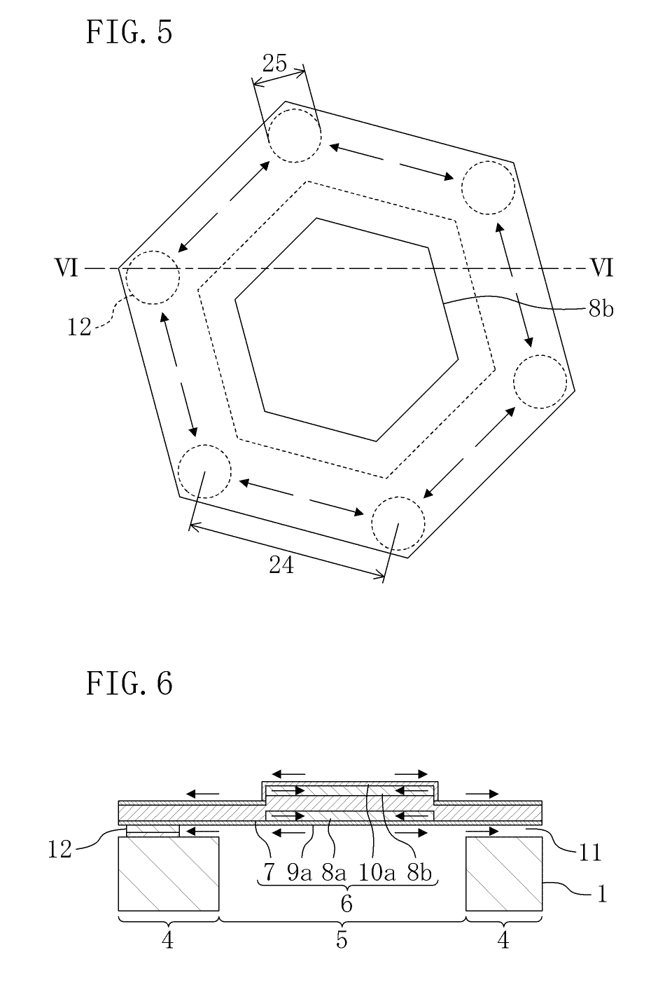

First, the acoustic transducer according to the second embodiment of the present disclosure will be described. FIG. 4 illustrates a cross-sectional view of the acoustic transducer according to the second embodiment of the present disclosure. FIG. 5 illustrates a planar structure of a vibrating film of the acoustic transducer according to the second embodiment of the present disclosure, and FIG. 6 illustrates a cross-sectional structure of the vibrating film of the acoustic transducer according to the second embodiment of the present disclosure. FIG. 6 illustrates a cross-sectional shape taken along the line VI-VI in FIG. 5. Here, the second embodiment is similar to the first embodiment except for the structure of a vibrating film 6. Therefore, FIGS. 5 and 6 will be described in detail. Operation of the acoustic transducer and the sensitivity indicating a characteristic of the acoustic transducer are similar to those in the first embodiment, and thus, will not be described.

As can be seen from FIG. 5, the vibrating film 6 forms a generally regular hexagonal shape in plan view, and each of restraining portions 12 forms a generally circular shape in plan view. However, the vibrating film 6 may form a polygonal shape, such as a generally quadrangular shape or a generally hexagonal shape, or a generally circular shape in plan view instead of a generally regular hexagonal shape. The restraining portion 12 may form a polygonal shape, such as a generally quadrangular shape or a generally hexagonal shape, in plan view instead of a generally circular shape. The reference character 24 denotes the distance between the centers of each adjacent pair of the restraining portions 12 (hereinafter referred to as L1), and the reference character 25 denotes the diameter of each restraining portion 12 (hereinafter referred to as L2).

As can be seen from FIG. 6, the vibrating film 6 includes a lower electrode 7 which is a substantially stress-free conductive film of polysilicon, etc., an insulating film 8a formed under the lower electrode 7 and made of silicon oxide, etc., with a compressive stress of ⁻500-⁻100 MPa, an insulating film 9a covering the lower surface of the insulating film 8a and made of silicon nitride, etc., with a tensile stress of 1000-2000 MPa, an insulating film 8b formed on the lower electrode 7 and made of silicon oxide, etc., with a compressive stress of ⁻500-⁻100 MPa, and an insulating film 10a covering the upper and side surfaces of the insulating film 8b and made of silicon nitride, etc., with a tensile stress of 1000-2000 MPa.

The silicon oxide films with a compressive stress of ⁻500-⁻100 MPa can be formed, for example, by chemical vapor deposition (CVD) using tetraethoxysilane. The silicon oxide films formed by CVD using silane-based gas also provide similar advantages as long as they are compressive stress inducing insulating films.

The silicon nitride films with a tensile stress of 1000-2000 MPa can be formed, for example, by CVD using silane-based gas and ammonia.

As can be seen from FIGS. 5 and 6, the directions of the stresses applied to the lower electrode 7, the insulating film 8a, the insulating film 8b, the insulating film 9a, and the insulating film 10a are illustrated by arrows. The vibrating film 6 includes the compressive stress inducing insulating films 8a and 8b, the substantially stress-free lower electrode 7, and the tensile stress inducing insulating films 9a and 10a. The compressive stress inducing insulating films 8a and 8b are formed within a removed substrate region 5. By contrast, the tensile stress inducing insulating films 9a and 10a are formed on the substantially entire surface of the lower electrode 7. Therefore, as illustrated in FIGS. 5 and 6, a tensile stress is applied from the restraining portions 12 to the vibrating film 6 on the air gap layer 11.

Moreover, the insulating film 8a and the insulating film 9a are preferably located under the substantially stress-free lower electrode 7, and the insulating film 8b and the insulating film 10a are preferably located on the substantially stress-free lower electrode 7. Furthermore, the thickness of the insulating film 8a is preferably equal to that of the insulating film 8b, and the thickness of the insulating film 9a is preferably equal to that of the insulating film 10a. The reason for this is that the stress distribution along a cross section of the vibrating film 6 is preferably symmetric with respect to the lower electrode 7.

Here, similar to the first embodiment, the vibrating film stiffness S₀ of the acoustic transducer of this embodiment will be described in detail.

As illustrated in FIG. 6, a portion of the vibrating film 6 located on the air gap layer 11 is released from a silicon substrate 1, i.e., not in contact with the silicon substrate 1. As illustrated in FIG. 5, a tensile stress from each restraining portion 12 is applied to the portion of the vibrating film 6 located on the air gap layer 11. Therefore, the vibrating film 6 and the silicon substrate 1 are not in contact with each other. Consequently, the residual stress caused due to the difference in thermal expansion coefficient between the vibrating film 6 and the silicon substrate 1 does not act on the vibrating film 6. In other words, the tensile stress from each restraining portion 12 due to the tensile stress inducing insulating films 9a and 10a can prevent the vibrating film 6 and the silicon substrate 1 from being in contact with each other.

In this embodiment, the insulating films 8a and 8b are located on the lower and upper surfaces, respectively, of the substantially stress-free lower electrode 7. With this structure, the stress distribution along a cross section of the vibrating film 6 is symmetric with respect to the lower electrode 7, thereby reducing film deformation arising from the stress differences among the layers forming the vibrating film 6.

Moreover, in this embodiment, the insulating film 8a and the insulating film 9a are preferably located on the lower surface of the substantially stress-free lower electrode 7, and the insulating film 8b and the insulating film 10a are preferably located on the upper surface thereof. Furthermore, the thickness of the insulating film 8a is preferably equal to that of the insulating film 8b, and the thickness of the insulating film 9a is preferably equal to that of the insulating film 10a. With this structure, the stress distribution along a cross section of the vibrating film 6 is symmetric with respect to the lower electrode 7, thereby further reducing film deformation arising from the stress differences among the layers forming the vibrating film 6.

Here, when the influence of the tensile stress inducing insulating films is too strong, a phenomenon occurs in which an unrestraining portion of the vibrating film 6 (the portion of the vibrating film 6 which is not restrained by the silicon substrate 1) is bent upward. Therefore, in order to reduce the upward bend in the vibrating film 6, the compressive stress inducing insulating films 8a and 8b are formed. This can reduce the influence of the tensile stress inducing insulating films 9a and 10a using the influence of the compressive stress inducing insulating films 8a and 8b. Consequently, the upward bend in the unrestraining portion of the vibrating film 6 can be reduced.

Therefore, referring to expression (5) described in the first embodiment, when the length L2 of the diameter 25 of each restraining portion 12 is set, e.g., at 50% of the distance L1 between the centers of each adjacent pair of the restraining portions 12, the tension S₀ of the vibrating film 6 per unit length thereof can be reduced to approximately 50% as compared with when the entire perimeter of the vibrating film 6 is restrained by the silicon substrate 1 without forming a plurality of spaced restraining portions 12. The reason for this is that deformation in the vibrating film 6 has been reduced. As a result, according to expressions (1) and (4) described in the first embodiment, the movable electrode area Sdia can be reduced to 50% without reducing the sensitivity S of the acoustic transducer, thereby reducing the chip size.

As described above, a major feature of the acoustic transducer of the second embodiment of the present disclosure is that the vibrating film has a multilayer structure in which the electrode, the first insulating film inducing a compressive stress, and the second insulating film inducing a compressive stress are laminated. Specifically, the vibrating film includes one more compressive stress inducing insulating film than in the first embodiment. Such a structure can further reduce the upward bend in the unrestraining portion of the vibrating film due to a too strong influence of the tensile stress even when a tensile stress acts on the vibrating film and the restraining portions through which the vibrating film and the silicon substrate are partially coupled together. This can further reduce film deformation arising from the stress differences among the layers forming the vibrating film.

The first insulating film inducing a compressive stress is preferably formed on the electrode, and the second insulating film inducing a compressive stress is preferably formed under the electrode. The reason for this is that such an arrangement facilitates allowing the stress distribution along a cross section of the vibrating film to be symmetric with respect to the electrode. Therefore, the advantages can be more easily provided.

The vibrating film preferably includes two tensile stress inducing insulating films, the first insulating film inducing a tensile stress is preferably formed on the first insulating film inducing a compressive stress, and the second insulating film inducing a tensile stress is preferably formed under the second insulating film inducing a compressive stress. Such a structure further facilitates allowing a tensile stress to act on the restraining portions. This further enhances the advantage provided by locating the compressive stress inducing insulating films within the electrode, and facilitates allowing the stress distribution along a cross section of the vibrating film to be symmetric with respect to the electrode.

### Fabrication Method of Second Embodiment

An example of a method for fabricating the acoustic transducer according to the second embodiment, i.e., a MEMS microphone, will be described hereinafter. Although like reference characters have been used to designate components identical with those illustrated in FIG. 4, such components are not restrictive. The components described in this embodiment are set fourth merely for purposes of examples.

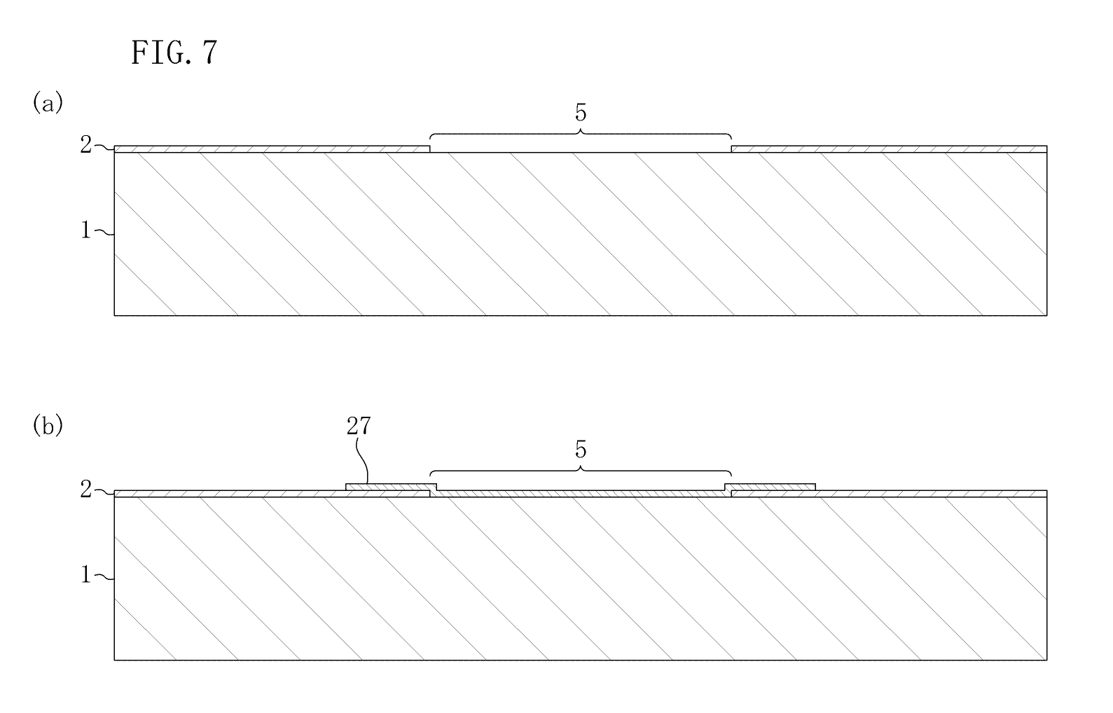

First, as illustrated in FIG. 7A, a first silicon oxide film 2 is formed on a silicon substrate 1 at the wafer level by thermal oxidation or CVD. Subsequently, an opening is selectively formed, by lithography and etching, in a region of the first silicon oxide film 2 corresponding to a removed substrate region 5 formed in a later process step.

Next, as illustrated in FIG. 7B, a first sacrificial layer 27 made of polysilicon doped with an impurity, such as phosphorus, is formed on the silicon substrate 1 to cover the opening in the first silicon oxide film 2.

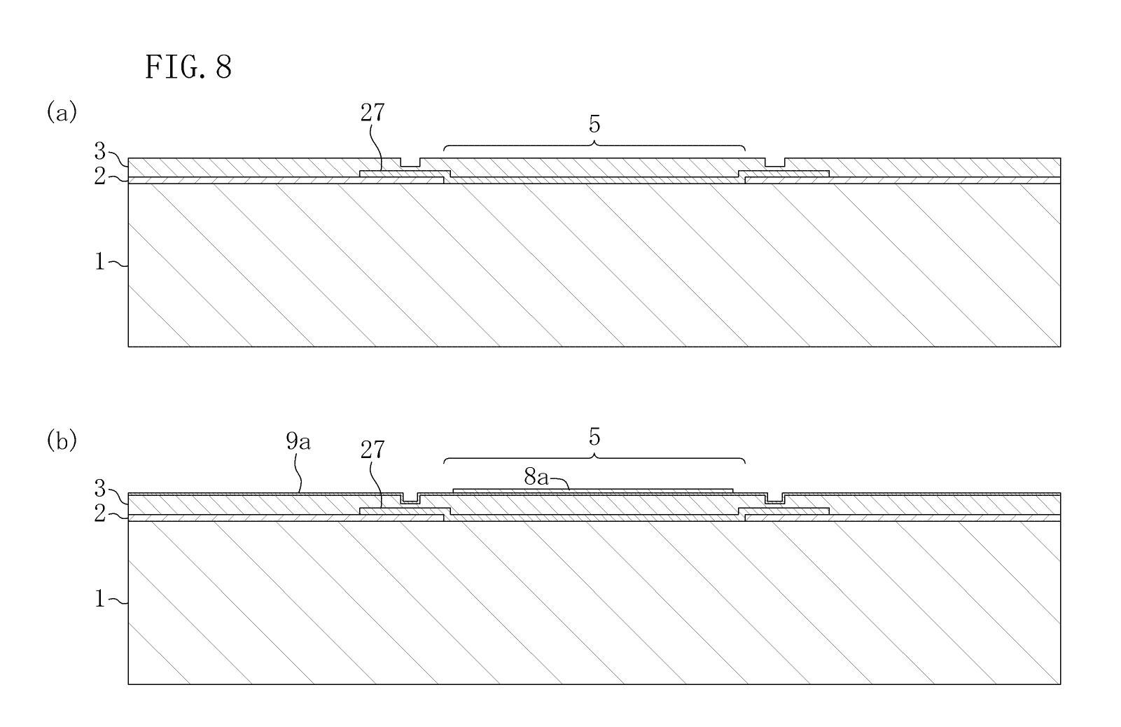

Next, as illustrated in FIG. 8A, a second silicon oxide film 3 is formed by CVD to cover the first sacrificial layer 27 and the first silicon oxide film 2. Here, portions of the first silicon oxide film 2 and portions of the second silicon oxide film 3 will form restraining portions 12 formed in a later process step. Subsequently, hinge grooves are formed in the second silicon oxide film 3. The hinge grooves remain finally as hinge portions of a vibrating film. Here, when the vibrating film is viewed from above, the multiple hinge portions are formed in an outer portion of the vibrating film, and when the vibrating film is viewed in cross section, the vibrating film has a repeatedly alternately raised and recessed surface. The vibration characteristics of the vibrating film can be improved by adjusting the stresses exerted on films forming the vibrating film using the hinge portions.

Next, as illustrated in FIG. 8B, a silicon nitride film 9a is formed on the second silicon oxide film 3 by CVD. Subsequently, a silicon oxide film (TEOS (tetra-ethyl-ortho-silicate) film) 8a is formed on the silicon nitride film 9a. Thereafter, the silicon oxide film 8a is patterned such that a portion of the silicon oxide film 8a corresponding to the removed substrate region 5 remains.

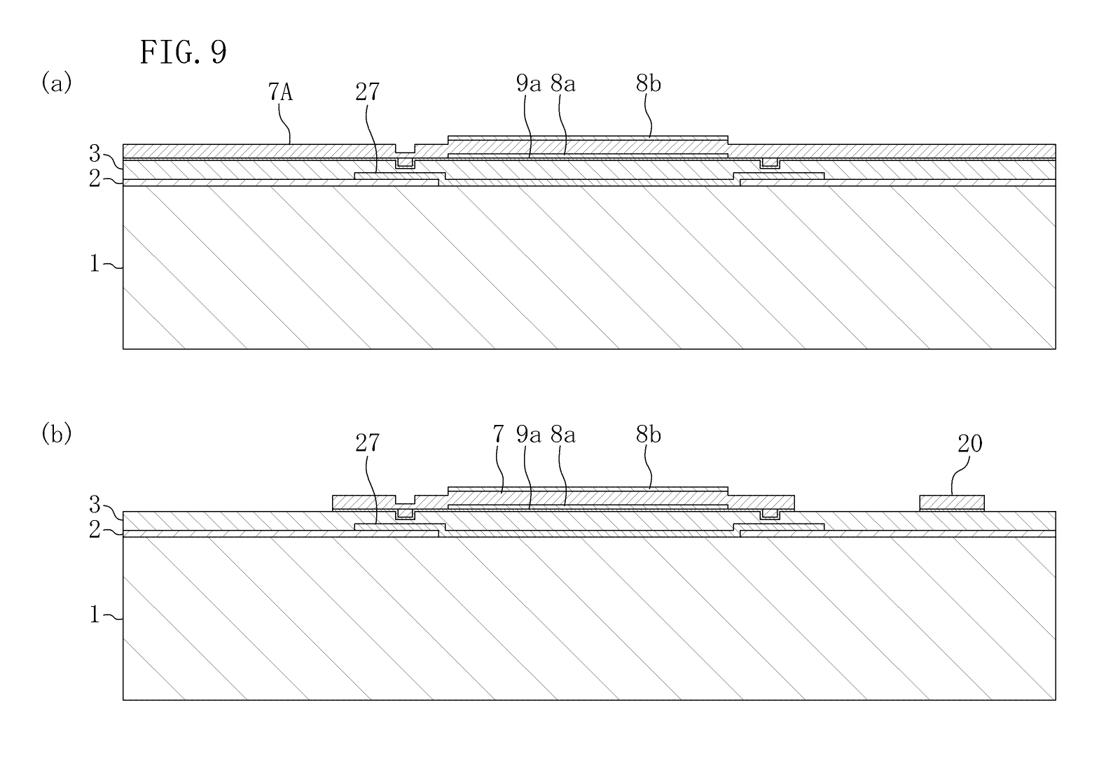

Next, as illustrated in FIG. 9A, a first polysilicon film 7A which will partially form a lower electrode and which is doped with an impurity, such as phosphorus, is formed by CVD to cover the silicon oxide film 8a and the silicon nitride film 9a. Subsequently, a silicon oxide film 8b is formed on the first polysilicon film 7A by CVD. Thereafter, the silicon oxide film 8b is patterned such that a portion of the silicon oxide film 8b corresponding to the silicon oxide film 8a remains.

Next, as illustrated in FIG. 9B, the first polysilicon film 7A and the silicon nitride film 9a are patterned such that their portions forming a vibrating film remain, thereby forming a lower electrode 7 from the first polysilicon film 7A.

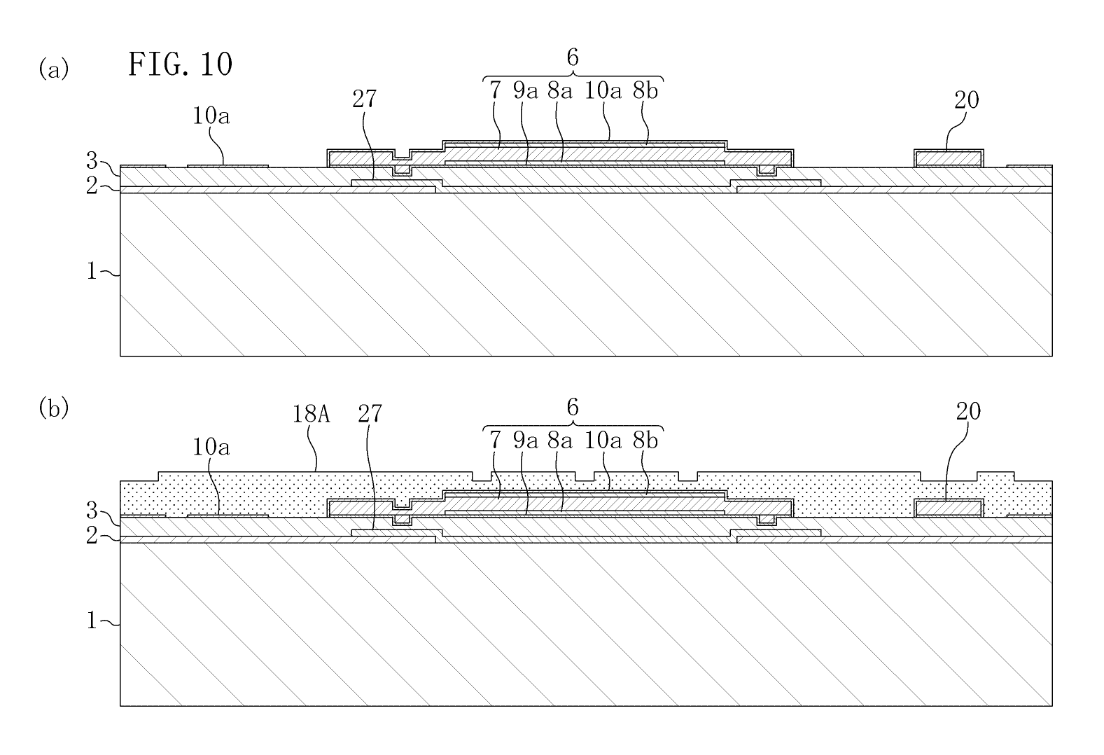

Next, as illustrated in FIG. 10A, a silicon nitride film 10a is formed by CVD to cover the second silicon oxide film 3, the lower electrode 7, and the silicon oxide film 8b. Thereafter, the formed silicon nitride film 10a is patterned such that a portion of the silicon nitride film 10 serving as a portion of the vibrating film and other necessary portions thereof remain. Thus, a vibrating film 6 is formed by interposing the lower electrode 7 between a combination of the silicon oxide film 8a and the silicon nitride film 9a and a combination of the silicon oxide film 8b and the silicon nitride film 10a. The combination of the silicon oxide film 8a and the silicon nitride film 9a is located on the lower surface of the lower electrode 7, and the combination of the silicon oxide film 8b and the silicon nitride film 10a is located on the upper surface thereof.

Next, as illustrated in FIG. 10B, a second sacrificial layer 18A made of silicon oxide is formed on the entire surface region of the silicon substrate 1, and furthermore grooves are formed in portions of the formed second sacrificial layer 18A corresponding to stopper portions for preventing sticking and pad portions 20 and 21. The stopper portions and the pad portion 21 are formed in a later process step. The stopper portions are projections formed to project from a fixed film formed in a later process step to the vibrating film to prevent adhesion (sticking) between the vibrating film and the fixed film.

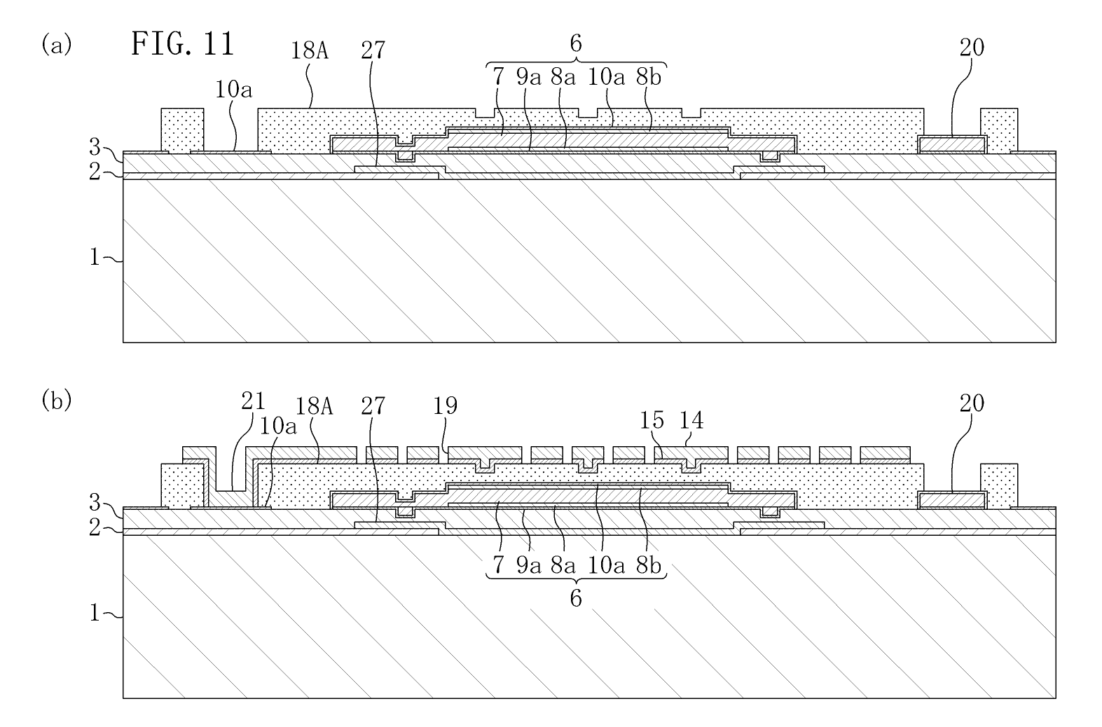

Next, as illustrated in FIG. 11A, openings are formed in portions of the second sacrificial layer 18A corresponding to the pad portion 20 and the pad portion 21 which is formed in a later process step.

Next, as illustrated in FIG. 11B, a silicon nitride film 15 and a second polysilicon film doped with an impurity, such as phosphorus, are sequentially formed on the entire surface region of the silicon substrate 1 by CVD. Thereafter, a plurality of openings are formed in portions of the formed silicon nitride film 15 and second polysilicon film corresponding to acoustic holes 19 formed in a later process step.

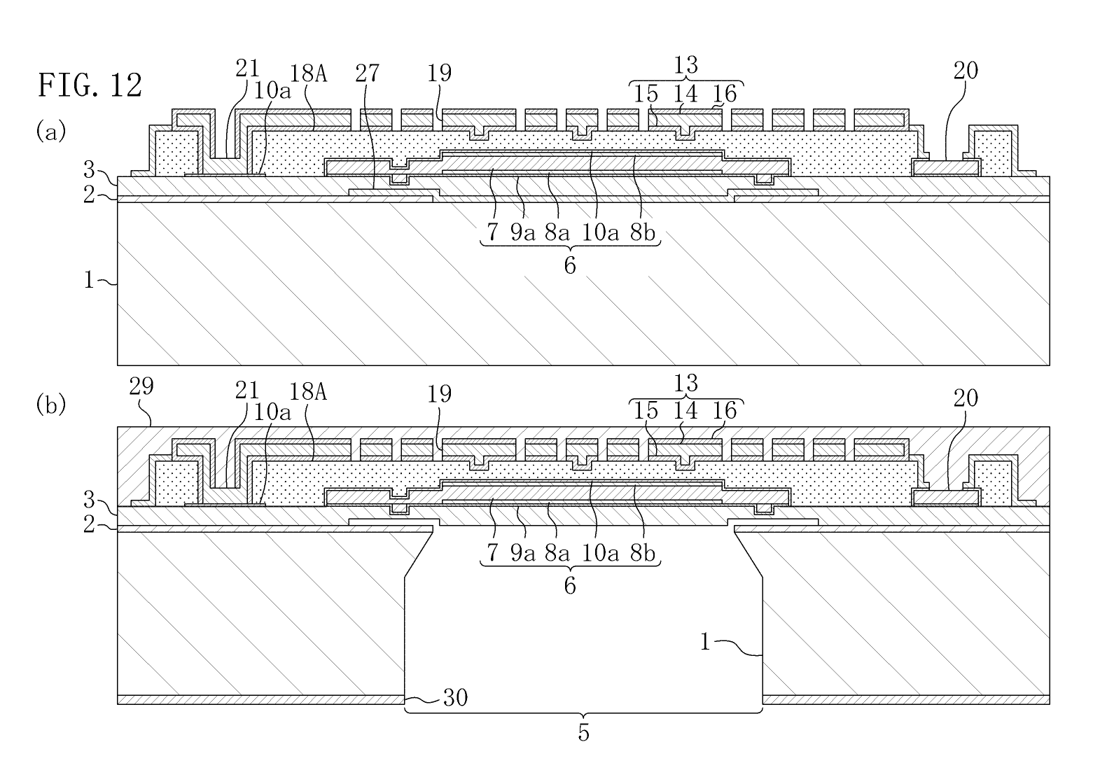

Next, as illustrated in FIG. 12A, a silicon nitride film 16 is formed on the entire surface region of the silicon substrate 1 by CVD. Thereafter, openings are formed in portions of the formed silicon nitride film 16 corresponding to the acoustic holes 19 formed in a later process step. Thus, a fixed film 13 is formed by interposing an upper electrode 14 made of the second polysilicon film between the insulating films (silicon nitride films) 15 and 16. The insulating film 15 is located on the lower surface of the upper electrode 14, and the insulating film 16 is located on the upper surface thereof.

Next, as illustrated in FIG. 12B, a first protective film 29 made of silicon oxide is formed on the entire surface region of the silicon substrate 1, and a second protective film 30 made of silicon oxide is formed also on the entire back surface of the silicon substrate 1. Subsequently, an opening pattern is formed by selectively etching a portion of the second protective film 30 corresponding to a removed substrate region 5. Thereafter, the silicon substrate 1 is etched from its back surface using the protective films 29 and 30 as masks to pass through the silicon substrate 1, thereby forming a removed substrate region 5 in the silicon substrate 1. Simultaneously, the first sacrificial layer 27 formed directly on the removed substrate region 5 is also removed.

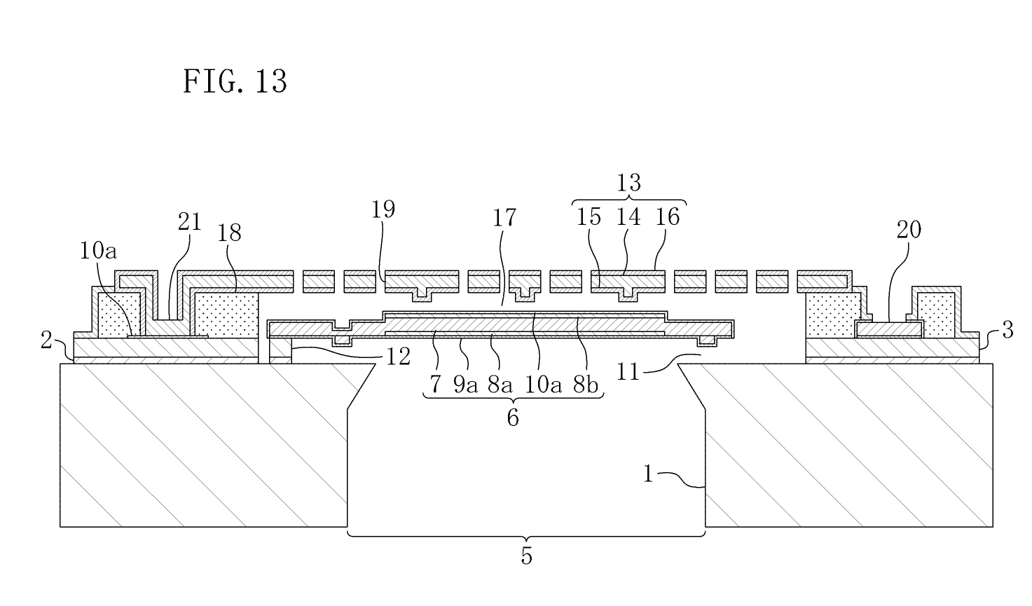

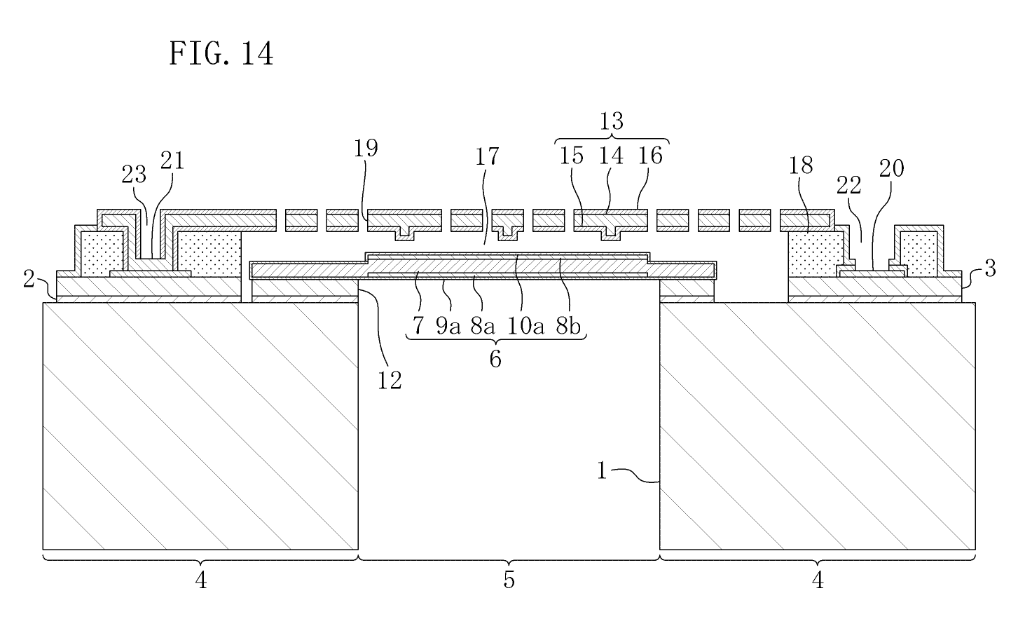

Next, as illustrated in FIG. 13, the silicon substrate 1 in which the removed substrate region 5 is formed is etched by wet etching. Specifically, the first protective film 29 and the second protective film 30 are removed, and the second sacrificial layer 18A is etched away through the plurality of acoustic holes 19 formed in the fixed film 13. Furthermore, a portion of the first silicon oxide film 2 located under the vibrating film 6 and a portion of the second silicon oxide film 3 located thereunder are removed such that a plurality of restraining portions 12 remain. Thereafter, in order to prevent adherence, i.e., so-called sticking, between the vibrating film 6 and the fixed film 13, supercritical drying is performed which is not affected by the liquid surface tension during drying.

As such, the MEMS microphone according to the second embodiment can be fabricated. Specifically, the vibrating film 6 is formed which includes the silicon nitride film 9a, the silicon oxide film 8a, the lower electrode 7 made of polysilicon, the silicon oxide film 8b, and the silicon nitride film 10a. Furthermore, the fixed film 13 is formed which includes the silicon nitride film 15, the upper electrode 14 made of polysilicon, and the silicon nitride film 16.

The air gap layer 17 is formed between the fixed film 13 and the vibrating film 6 by removing a portion of the second sacrificial layer 18A. The remaining portion of the second sacrificial layer 18A forms a support portion 18 for supporting the fixed film 13.

### Variation of Second Embodiment

An acoustic transducer according to a variation of the second embodiment of the present disclosure will be described hereinafter with reference to FIGS. 14-16.

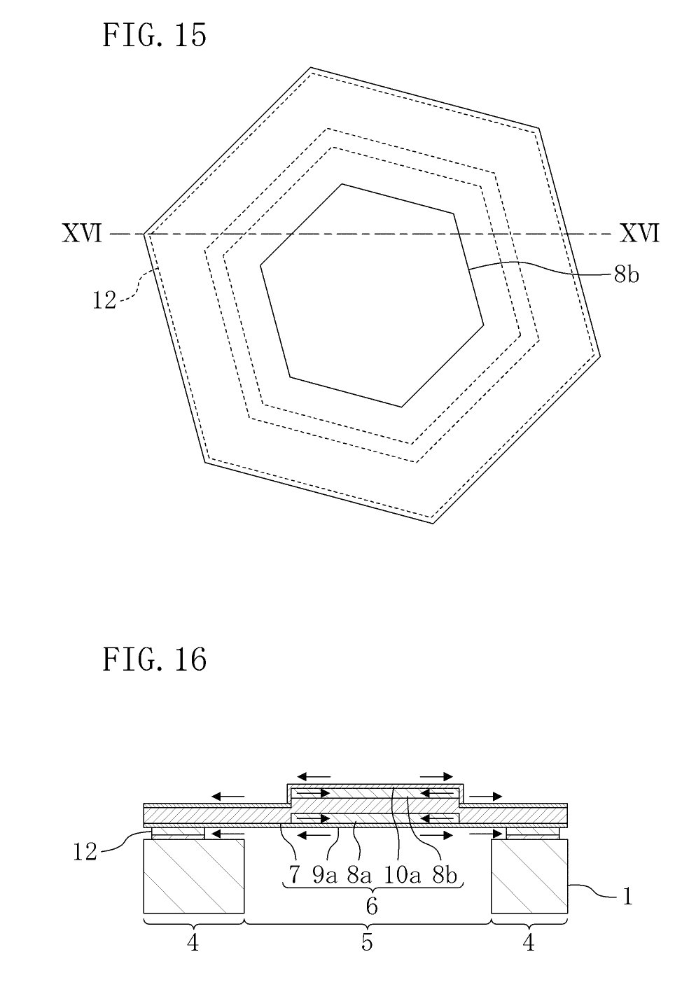

FIG. 14 illustrates a cross-sectional view of the acoustic transducer according to the variation of the second embodiment of the present disclosure. FIG. 15 illustrates a planar structure of a vibrating film of the acoustic transducer according to the variation of the second embodiment of the present disclosure, and FIG. 16 illustrates a cross-sectional structure of the vibrating film of the acoustic transducer according to the variation of the second embodiment of the present disclosure. FIG. 16 illustrates a cross-sectional shape taken along the line XVI-XVI in FIG. 15.

Here, the variation of the second embodiment is similar to the second embodiment except for the structure of a restraining portion through which the vibrating film and a silicon substrate are structurally coupled together. Specifically, in this variation, an outer portion of the vibrating film and the silicon substrate are substantially entirely restrained without being partially restrained. When this structure is employed, the area of an unrestraining portion is small, and thus, the phenomenon is less likely to occur in which the vibrating film is bent upward. However, variation in the sensitivity characteristic needs to be reduced by reducing deformation in the vibrating film. In this case, the vibrating film 6 is configured such that while insulating films 8b and 10a are located on a substantially stress-free lower electrode 7, insulating films 8a and 9a are located under the lower electrode 7, thereby facilitating allowing the stress distribution along a cross section of the vibrating film 6 to be symmetric. This facilitates reducing film deformation arising from the stress differences among the layers forming the vibrating film 6. The thicknesses of the insulating films 8a and 9a are equal to those of the insulating films 8b and 10a, respectively, and the lower electrode 7 is interposed between a combination of the insulating films 8a and 9a and a combination of the insulating films 8b and 10a, thereby allowing the stress distribution along a cross section of the vibrating film 6 to be symmetric. This can further reduce film deformation arising from the stress differences among the layers forming the vibrating film 6. As such, when the stress distribution of the multilayer vibrating film 6 is symmetric, this leads to a reduction in film deformation arising from the stress differences among the layers forming the vibrating film 6. Therefore, variation in the distance d₀ between the upper and lower electrodes, i.e., the air gap capacitance Ca, is reduced, thereby providing a desired sensitivity characteristic.

### Third Embodiment

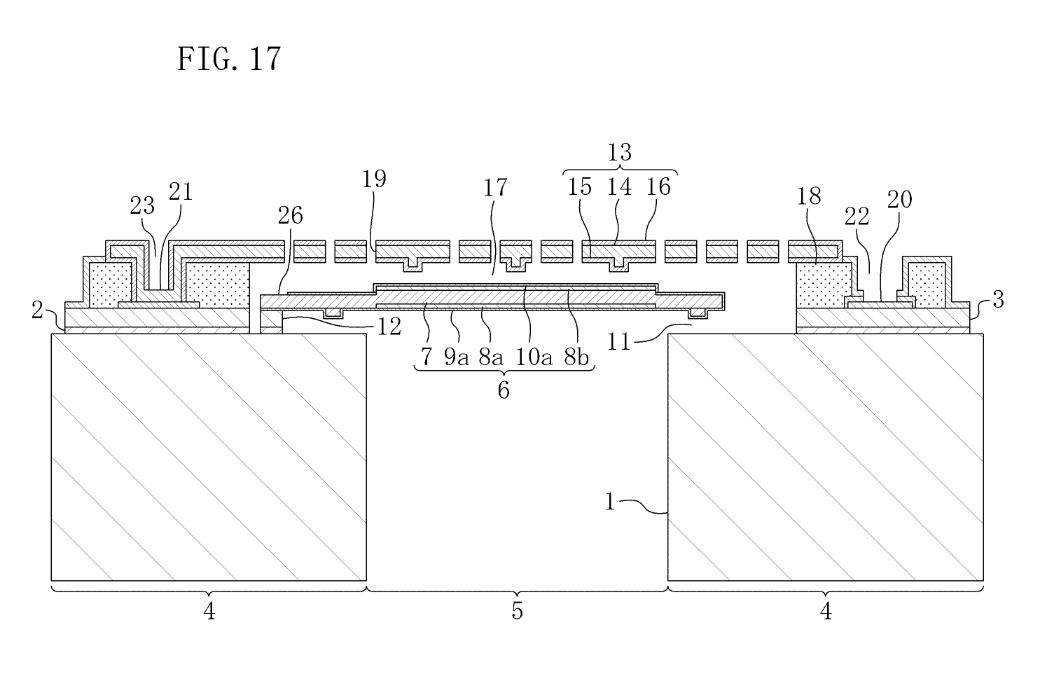

An acoustic transducer according to a third embodiment of the present disclosure will be described hereinafter with reference to FIGS. 17-19. The drawings, various shapes, materials, and numeric values which will be described below are all set forth merely for purposes of preferred examples, and are not limited to the contents described below. Appropriate changes can be made without being limited to the description below as long as doing so does not depart from the spirit of the invention. Furthermore, this embodiment can be also combined with other embodiments as long as this embodiment is consistent with the other embodiments. Although an acoustic transducer is described here while being used as an example of a MEMS device, the present disclosure can be practiced with general MEMS devices.

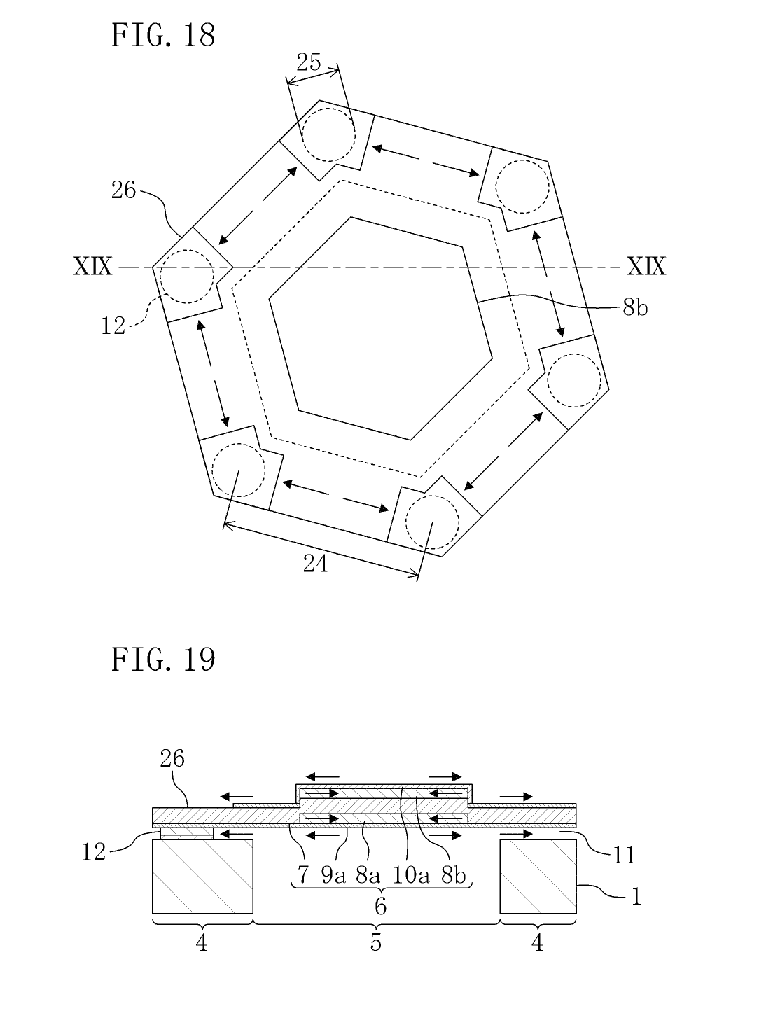

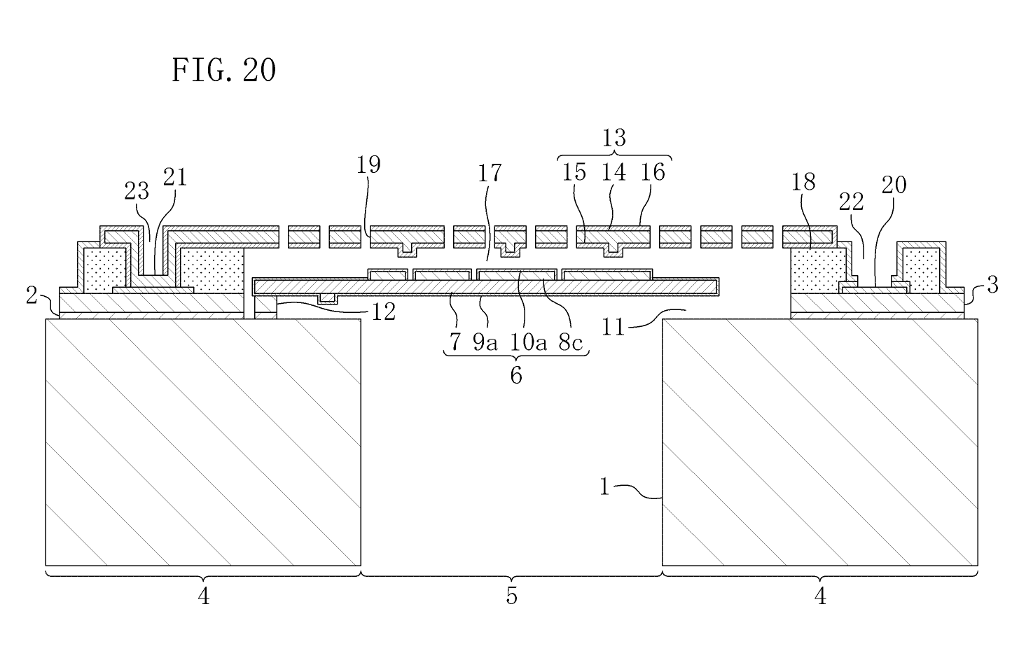

FIG. 17 illustrates a cross-sectional view of the acoustic transducer according to the third embodiment of the present disclosure. FIG. 18 illustrates a planar structure of a vibrating film of the acoustic transducer according to the third embodiment of the present disclosure, and FIG. 19 illustrates a cross-sectional structure of the vibrating film of the acoustic transducer according to the third embodiment of the present disclosure. FIG. 19 illustrates a cross-sectional shape taken along the line XIX-XIX in FIG. 18. Here, the third embodiment is similar to the first and second embodiments except for the planar shape of an insulating film 10a, such as a tensile stress inducing silicon nitride film, formed in the vibrating film. Therefore, a portion of the acoustic transducer different from that in each of the first and second embodiments will be described in detail with reference to FIGS. 18 and 19. Operation of the acoustic transducer and the sensitivity indicating a characteristic of the acoustic transducer are similar to those in the first embodiment, and thus, will not be described. Although FIGS. 17-19 illustrate a variation of the structure of the vibrating film illustrated in FIGS. 4-6, the structure of the vibrating film illustrated in FIGS. 1-3 may be changed.

As can be seen from FIGS. 18 and 19, in the third embodiment, similar to the first and second embodiments, the acoustic transducer includes a vibrating film 6 partially coupled to a silicon substrate 1 through restraining portions 12. Portions, which are located over and in the vicinity of the restraining portions 12, of the insulating film 10a, such as a tensile stress inducing silicon nitride film, formed on a lower electrode 7 forming a portion of the vibrating film 6 are selectively removed, thereby forming regions 26 corresponding to the selectively removed portions. In other words, the tensile stress inducing insulating film 10a is formed on a portion of the lower electrode 7 other than portions thereof located over the restraining portions 12 and their surrounding areas.

Such an advantage as described below can be expected from the above-described structure of the acoustic transducer according to the third embodiment as compared with the acoustic transducers according to the first and second embodiments. Specifically, since the restraining portions 12 are coupled to portions of the vibrating film 6, this tends to cause stress concentration. Therefore, as described in the third embodiment, the regions 26 are formed in which portions of the insulating film 10a located over and in the vicinity of the restraining portions 12 are selectively removed, thereby reducing the stress concentration on the restraining portions 12. This increases the breakdown resistance of the vibrating film 6, thereby improving processing yield.

Although not shown in FIGS. 17-19, a similar advantage can be provided also by forming regions in which portions, located on and in the vicinity of the restraining portions 12, of the tensile stress inducing insulating film 9a formed under the lower electrode 7 are selectively removed. When regions are formed in which portions, located over and in the vicinity of the restraining portions 12, of both of the tensile stress inducing insulating films 10a and 9a formed on the upper and lower surface, respectively, of the lower electrode 7 are selectively removed, this can further increase the breakdown resistance of the vibrating film 6.

### Fourth Embodiment

An acoustic transducer according to a fourth embodiment of the present disclosure will be described hereinafter with reference to FIGS. 20-22. The drawings, various shapes, materials, and numeric values which will be described below are all set forth merely for purposes of preferred examples, and are not limited to the contents described below. Appropriate changes can be made without being limited to the description below as long as doing so does not depart from the spirit of the invention. Furthermore, this embodiment can be also combined with other embodiments as long as this embodiment is consistent with the other embodiments. Although an acoustic transducer is described here while being used as an example of a MEMS device, the present disclosure can be practiced with general MEMS devices.

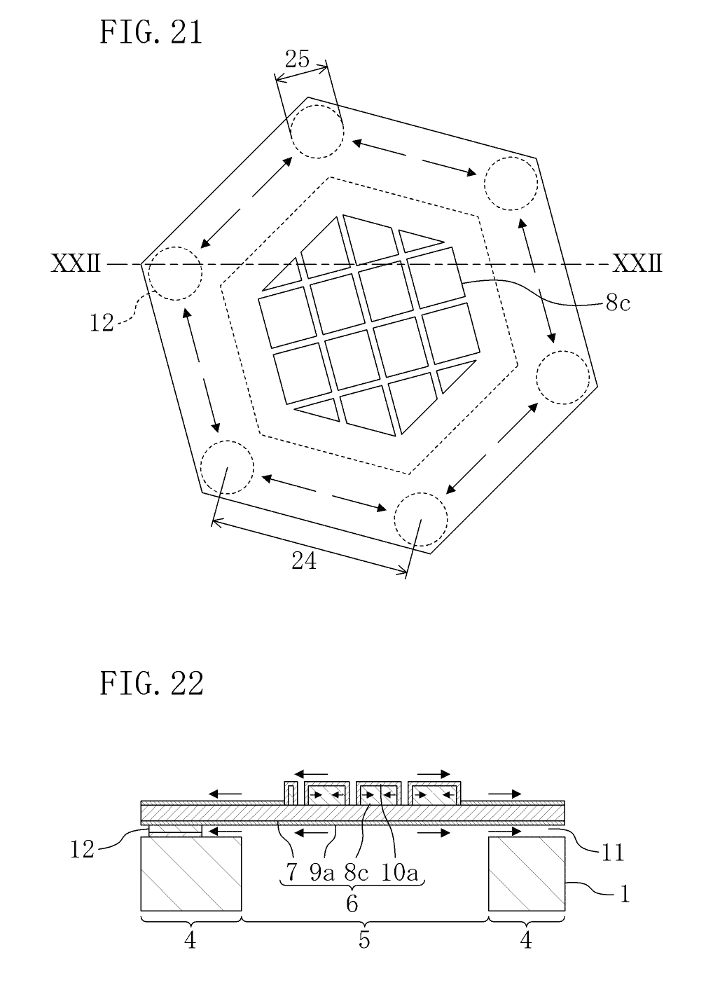

FIG. 20 illustrates a cross-sectional view of the acoustic transducer according to the fourth embodiment of the present disclosure. FIG. 21 illustrates a planar structure of a vibrating film of the acoustic transducer according to the fourth embodiment of the present disclosure, and FIG. 22 illustrates a cross-sectional structure of the vibrating film of the acoustic transducer according to the fourth embodiment of the present disclosure. FIG. 22 illustrates a cross-sectional shape taken along the line XXII-XXII in FIG. 21. Here, the fourth embodiment is similar to the first and second embodiments except for the shape of an insulating film 8c, such as a compressive stress inducing silicon oxide film, formed in the vibrating film 6. Therefore, a portion of the acoustic transducer different from that in each of the first and second embodiments will be described in detail with reference to FIGS. 21 and 22. Operation of the acoustic transducer and the sensitivity indicating a characteristic of the acoustic transducer are similar to those in the first embodiment, and thus, will not be described. Although FIGS. 20-22 illustrate a variation of the structure of the vibrating film illustrated in FIGS. 1-3, the structure of the vibrating film illustrated in FIGS. 4-6 may be changed.

As can be seen from FIGS. 21 and 22, in this embodiment, similar to the first and second embodiments, the acoustic transducer includes a vibrating film 6 partially coupled to a silicon substrate 1 through restraining portions 12. A plurality of grooves are formed in a compressive stress inducing insulating film 8c formed on a lower electrode 7, forming a portion of the vibrating film 6, and made of silicon oxide, etc., to cross one another in generally straight lines. The compressive stress inducing insulating film 8c is separated into a plurality of sections by the plurality of grooves. In other words, the compressive stress inducing insulating film 8c has a planar shape in which island-like patterns are formed by the plurality of grooves.

Such an advantage as described below can be expected from the above-described structure of the acoustic transducer according to the fourth embodiment as compared with the acoustic transducers according to the first and second embodiments. Specifically, the compressive stress inducing insulating film 8c is located within the lower electrode 7, and is localized in a central portion of the vibrating film 6. This tends to cause local stress concentration on the central portion of the vibrating film 6. Therefore, when a strong compressive stress is exerted on the central portion of the vibrating film 6, the central portion of the vibrating film 6 may be bent upward. Therefore, as described in the fourth embodiment, the compressive stress inducing insulating film 8c is separated into a plurality of sections by the plurality of grooves, thereby reducing stress concentration on the central portion of the vibrating film 6. This can reduce the upward bend in the central portion of the vibrating film 6, thereby further reducing film deformation arising from the stress differences among the layers forming the vibrating film 6.

Although not shown in FIGS. 20-22, when a compressive stress inducing insulating film is formed under the lower electrode 7, the compressive stress inducing insulating film formed under the lower electrode 7 may be separated into a plurality of sections by a plurality of grooves. This can also provide a similar advantage. The compressive stress inducing insulating films formed on the upper and lower surfaces of the lower electrode 7 may be each separated into a plurality of sections by a plurality of grooves.

Here, MEMS devices described in all the embodiments will be described. A MEMS technique refers to a technique in which a substrate (wafer) on which a number of chips have been fabricated simultaneously using a fabrication process technique for complementary metal-oxide semiconductors (CMOS), etc., is cut into individual chips, to obtain devices, such as capacitive condenser microphones and pressure sensors. Devices fabricated using such a MEMS technique are called MEMS devices.

A MEMS device, such as an acoustic transducer, according to the present disclosure controls the stress distribution of a multilayer low-stress vibrating film to reduce deformation in the vibrating film, thereby providing desired characteristics and reducing the area of the vibrating film, i.e., a movable electrode. Thus, the MEMS device is useful for MEMS devices, etc., including a multilayer vibrating film.

What is claimed is:

1. A MEMS device comprising:
a semiconductor substrate;
a vibrating film formed on the semiconductor substrate with a restraining portion interposed between the vibrating film and the semiconductor substrate, the vibrating film including a first electrode, and
a fixed film formed on the semiconductor substrate with a support portion interposed between the fixed film and the semiconductor substrate to cover the vibrating film, the fixed film including a second electrode,
wherein the support portion is configured to provide an air gap between the vibrating film and the fixed film,
the restraining portion provides partial coupling between the semiconductor substrate and the vibrating film,
the vibrating film has a multilayer structure in which the first electrode and a first insulating film inducing a compressive stress are laminated, and
the first insulating film is located within the perimeter of the first electrode.

2. The MEMS device of claim 1, wherein
the vibrating film includes a second insulating film inducing a tensile stress and a third insulating film inducing a tensile stress,
the second insulating film is formed on the first insulating film, and
the third insulating film is formed under the first insulating film.

3. The MEMS device of claim 2, wherein
at least one of the second and third insulating films is formed on a first region of the vibrating film so that a second region of the vibrating film including the restraining portion and a surrounding area of the restraining portion is uncovered by the at least one of the second and third insulating films.

4. The MEMS device of claim 1, wherein
a plurality of grooves are formed in the first insulating film to cross one another, and
the first insulating film is separated into a plurality of sections by the grooves.

5. The MEMS device of claim 2, wherein
the second and third insulating films are silicon nitride films.

6. The MEMS device of claim 1, wherein
the first insulating film is a silicon oxide film.

7. A MEMS device comprising:
a semiconductor substrate;
a vibrating film formed on the semiconductor substrate with a restraining portion interposed between the vibrating film and the semiconductor substrate, the vibrating film including a first electrode, and
a fixed film formed on the semiconductor substrate with a support portion interposed between the fixed film and the semiconductor substrate to cover the vibrating film, the fixed film including a second electrode,
wherein the support portion is configured to provide an air gap between the vibrating film and the fixed film opposed to each other,
the restraining portion provides partial coupling between the semiconductor substrate and the vibrating film,
the vibrating film has a multilayer structure in which the first electrode, and a first insulating film inducing a compressive stress, and a second insulating film inducing a compressive stress are laminated,
the first insulating film is formed on the first electrode, and
the second insulating film is formed under the first electrode.

8. The MEMS device of claim 7, wherein
the vibrating film includes a third insulating film inducing a tensile stress and a fourth insulating film inducing a tensile stress,
the third insulating film is formed on the first insulating film, and
the fourth insulating film is formed under the second insulating film.

9. The MEMS device of claim 8, wherein
at least one of the third and fourth insulating films is formed on a first region of the vibrating film so that a second region including the restraining portion and a surrounding area of the restraining portion is uncovered by the at least one of the third and fourth insulating films.

10. The MEMS device of claim 7, wherein
a plurality of grooves are formed in the first insulating film to cross one another, and
the first insulating film is separated into a plurality of sections by the grooves.

11. The MEMS device of claim 7, wherein
a plurality of grooves are formed in the second insulating film to cross one another, and
the second insulating film is separated into a plurality of sections by the grooves.

12. The MEMS device of claim 8, wherein
the third and fourth insulating films are silicon nitride films.

13. The MEMS device of claim 7, wherein
the first and second insulating films are silicon oxide films.

14. The MEMS device of claim 1, wherein
the first insulating film is formed on a first region of the vibrating film so that a second region located over the restraining portion is uncovered by the first insulating film.

15. The MEMS device of claim 7, wherein
the first insulating film is formed on a first region of the vibrating film so that a second region located over the restraining portion is uncovered by the first insulating film.

16. The MEMS device of claim 1, wherein
the semiconductor substrate includes a through hole, and
the first insulating film is formed only over the end of the through hole located in the surface of the semiconductor substrate on which the restraining portion is formed.

17. The MEMS device of claim 7, wherein
the semiconductor substrate includes a through hole, and
the first insulating film is formed only over the end of the through hole located in the surface of the semiconductor substrate on which the restraining portion is formed.

18. The MEMS device of claim 2, wherein
a side surface of the first insulating film is covered with the second insulating film or the third insulating film.

19. The MEMS device of claim 8, wherein
the third insulating film is further formed on a side surface of the first insulating film.

20. A MEMS device comprising:
a semiconductor substrate;
a vibrating film having a multilayer structure including a first electrode and an insulating film, the vibrating film connected to the semiconductor substrate by a plurality of restraining portions disposed on the semiconductor substrate at a predetermined interval so that the vibrating film is partially released from the semiconductor substrate; and
a fixed film including a second electrode, the fixed film connected to the substrate by a support portion,
wherein the fixed film and the vibrating film are configured to provide an air gap therebetween,
wherein the insulating film is formed on a first region of the vibrating film so that a second region of the vibrating film including the plurality of restraining portions and a surrounding area of the plurality of restraining portions is uncovered by the insulating film.

21. The MEMS device of claim 20, wherein the predetermined interval is substantially equal to two times a center distance of each of the plurality of restraining portions.
